(19) United States
(12) Patent Application Publication
(10) Pub. No.: US 2024/0420358 A1
(43) Pub. Date: Dec. 19, 2024

(54) VOLUME MANAGEMENT SYSTEM

(71) Applicant: Deep-In-Sight Co., Ltd., Seongnam-si (KR)

(72) Inventors: Daniel HONG, Seongnam-si (KR); Eunsong OH, Yongin-si (KR); Kyoungsuk OH, Incheon (KR); Inchan JI, Seongnam-si (KR)

(21) Appl. No.: 18/601,688

(22) Filed: Mar. 11, 2024

(30) Foreign Application Priority Data
Jun. 14, 2023 (KR) 10-2023-0075920

(51) Int. Cl. G06T 7/62; G06T 7/50; G06T 7/80

(52) U.S. Cl. CPC G06T 7/62; G06T 7/50; G06T 7/80; G06T 2207/10028

(57) ABSTRACT

Disclosed is a volume measurement method performed by a computing device. The method may include acquiring, by a 3D sensing unit, a target depth image for a target object positioned on a reference surface. The 3D sensing unit has a sensing direction which is an acute angle with respect to the reference surface. The method may include acquiring point cloud data for a sensing coordinate system based on the target depth image. The method may include acquiring point cloud data for a reference surface coordinate system by using transformation relationship information between the sensing coordinate system and the reference surface coordinate system for the sensing direction.

### CROSS-REFERENCE TO RELATED APPLICATIONS

This application claims priority to and the benefit of Korean Patent Application No. 10-2023-0075920 filed in the Korean Intellectual Property Office on Jun. 14, 2023, the entire contents of which are incorporated herein by reference.

### BACKGROUND

### Technical Field

The present disclosure relates to a volume measurement system (VMS).

### Description of the Related Art

A parcel delivery service means any transportation service from reception of a cargo to packaging, transportation, and delivery of the cargo by receiving a request transportation of small-sized cargos and small-quantity of cargos from the individual or company. In recent years, the use of parcel delivery services for delivery of goods sold is rapidly increasing as goods trading through domestic and foreign online shopping malls, TV home shopping, and used goods sales sites are becoming more active. In addition, the frequency of personal use of parcel delivery services is increasing rapidly due to returning delivered goods or exchange of goods between individuals.

### BRIEF SUMMARY

The inventors of the present disclosure have appreciated the need to increase logistics loading and transportation efficiency. Accordingly, various embodiments of the present disclosure provide a volume measurement system (VMS) that can efficiently measure the volume as well as weights of objects having various sizes. The present disclosure discloses various volume measurement methods and volume measurement apparatus for the volume measurement system.

An exemplary embodiment of the present disclosure provides a method performed by a computing device. The method may include acquiring, by a 3D sensing unit, a target depth image for a target object positioned on a reference surface. The 3D sensing unit has a sensing direction which is an acute angle with respect to the reference surface. The method may include acquiring point cloud data for a sensing coordinate system based on the target depth image. The method may include acquiring point cloud data for a reference surface coordinate system by using transformation relationship information between the sensing coordinate system and the reference surface coordinate system for the sensing direction.

Alternatively, the transformation relationship information between the sensing coordinate system and the reference surface coordinate system may include a rotation transformation matrix and a translation transformation matrix.

Alternatively, the rotation transformation matrix may be a unit vector matrix of the reference surface according to the sensing coordinate system, and the rotation transformation matrix may be a centroid matrix of the point cloud data corresponding to the reference surface according to the sensing coordinate system.

Alternatively, the transformation relationship information between the sensing coordinate system and the reference surface coordinate system may be based on Equation 1.

$${p}^{p} = {R}^{T} {p}^{c} - {R}^{T} t \qquad Equation 1$$

Where, p^{c} may represent the sensing coordinate system, p^{p} may represent the reference surface coordinate system, R^{T} may represent a transposed matrix of the rotation transformation matrix, and t may represent the translation transformation matrix.

Alternatively, the method may further include determining the transformation relationship information between the sensing coordinate system and the reference surface coordinate system for the sensing direction.

Alternatively, the determining of the transformation relationship information between the sensing coordinate system and the reference surface coordinate system for the sensing direction may include acquiring, by the 3D sensing unit, a calibration depth image for the reference surface based on the sensing direction, acquiring point cloud data corresponding to the reference surface based on the calibration depth image, determining an equation of a plane for the reference surface based on the point cloud data corresponding to the reference surface, and determining the transformation relationship information between the sensing coordinate system and the reference surface coordinate system for the sensing direction based on the equation of the plane for the reference surface.

Alternatively, the determining of the equation of the plane for the reference surface based on the point cloud data corresponding to the reference surface may include determining the equation of the plane by applying a singular value decomposition to the point cloud data corresponding to the reference surface.

Alternatively, the point cloud data for the reference surface coordinate system may include a bird-eye view image corresponding to the target depth image.

Alternatively, the method may further include determining a volume of the target object based on the point cloud data for the reference surface coordinate system.

Alternatively, the determining of the volume of the target object based on the point cloud data for the reference surface coordinate system may include identifying a top surface of the target object in order to determine a height of the target object when the target object has a rectangular parallelepiped shape.

Alternatively, the determining of the volume of the target object based on the point cloud data for the reference surface coordinate system may include determining a cube type bounding box of the target object based on the point cloud data for the reference surface coordinate system when the target object has an atypical shape, and determining approximate values of a width, a length, and a height of the target object by using the cube type bounding box of the target object.

Another exemplary embodiment of the present disclosure provides a non-transitory computer readable storage storing a computer program. The computer program may include instructions for causing one or more processors to perform the following method, and the method may include: acquiring, by a 3D sensing unit, a target depth image for a target object positioned on a reference surface, wherein the 3D sensing unit has a sensing direction which is an acute angle with respect to the reference surface; acquiring point cloud data for a sensing coordinate system based on the target depth image; and acquiring point cloud data for a reference surface coordinate system by using transformation relationship information between the sensing coordinate system and the reference surface coordinate system for the sensing direction.

Yet another exemplary embodiment of the present disclosure provides a volume measurement apparatus. The apparatus may include: a 3D sensing unit having a sensing direction which is an acute angle with respect to a reference surface; a body structure forming an exterior of the volume measurement apparatus, and arranging a stand having an upper plane on which a target object may be placed and the 3D sensing unit to face the upper plane; and a control unit, in which the control unit may acquire a target depth image for the target object positioned on a reference surface by the 3D sensing unit, acquire point cloud data for a sensing coordinate system based on the target depth image, acquire point cloud data for a reference surface coordinate system by using transformation relationship information between the sensing coordinate system and the reference surface coordinate system for the sensing direction, and determine a volume of the target object based on the point cloud data for the reference surface coordinate system.

According to an exemplary embodiment of the present disclosure, provided are a volume measurement method and a volume measurement apparatus for a volume measurement system.

### BRIEF DESCRIPTION OF THE SEVERAL VIEWS OF THE DRAWINGS

FIG. 1 is a block diagram of a volume measurement apparatus according to some exemplary embodiments of the present disclosure.

FIG. 2 is a diagram for describing a process of acquiring a calibration depth image for a reference surface based on a sensing direction according to some exemplary embodiments of the present disclosure.

FIG. 3 is a diagram illustrating the calibration depth image indicating an area corresponding to the reference surface according to some exemplary embodiments of the present disclosure.

FIG. 4 is a diagram displaying point cloud data corresponding to the reference surface acquired from the calibration depth image according to some exemplary embodiments of the present disclosure.

FIG. 5 illustrates a plane defined by an equation of a plane corresponding to the point cloud data for the reference surface according to some exemplary embodiments of the present disclosure.

FIG. 6 is a diagram for describing a sensing coordinate system and a reference surface coordinate system according to some exemplary embodiments of the present disclosure.

FIG. 7 is a diagram for describing a step of acquiring a target depth image for a target object positioned on the reference surface.

FIG. 8 illustrates an exemplary target depth image acquired by a 3D sensing unit having a sensing direction which is an acute angle for the reference surface.

FIG. 9 is a diagram for describing the point cloud data for the reference surface coordinate system acquired by transformation relationship information between the sensing coordinate system and the reference surface coordinate system for the sensing direction.

FIG. 10 is a flowchart of a volume measurement method according to some exemplary embodiments of the present disclosure.

FIG. 11 is a simple and normal schematic view of an exemplary computing environment in which the exemplary embodiments of the present disclosure may be implemented.

### DETAILED DESCRIPTION

Various exemplary embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an exemplary embodiment disclosed in the present disclosure, a detailed description of related known technologies will be omitted if it is determined that the detailed description makes the gist of the exemplary embodiment of the present disclosure unclear. Further, the accompanying drawings are only for easily understanding the exemplary embodiment disclosed in this specification and the technical spirit disclosed by this specification is not limited by the accompanying drawings.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second clement or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

The word “comprises” and/or “comprising” means that the corresponding feature and/or component is present, but it should be appreciated that presence or addition of one or more other features, components, and/or a group thereof is not excluded. Further, when not separately specified or it is not clear in terms of the context that a singular form is indicated, it should be construed that the singular form generally means “one or more” in this specification and the claims.

The terms “information” and “data” used in the specification may also be often used to be exchanged with each other.

Elements or layers of different layers or layers being referred to as being “on” or “on” other components or layers includes both a case where the elements or layers are directly on other components or layers, and a case where the elements or layers are interposed in the middle with other layers or other components. On the contrary, the component being referred to as being “directly on” or “just on” indicates that another component or layer is not interposed therebetween.

“Below”, “beneath”, “lower”, “above”, “upper”, etc., which are spatially relative terms may be used for easily describing a correlation between one component or other components as illustrated in the drawings. The spatially relative terms should be appreciated as terms including different directions of elements upon using or operating in addition to directions illustrated in the drawings.

For example, when the components illustrated in the drawings are overturned, the components described as “below” or “beneath” the other components may be placed “above” the other components. Thus, the exemplary term “below” may include both the below direction and the above direction. The components may be oriented even in different directions, and thus, the spatially relative terms may be interpreted according to the orientation.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another component, no component is present therebetween.

Suffixes “module” and “unit” for components used in the following description are given or mixed in consideration of easy preparation of the specification only and do not have their own distinguished meanings or roles.

The term “unit” as used herein may include any electrical circuitry, features, components, an assembly of electronic components or the like. That is, “unit” may include any processor-based or microprocessor-based system including systems using microcontrollers, integrated circuit, chip, microchip, reduced instruction set computers (RISC), application specific integrated circuits (ASICs), field-programmable gate arrays (FPGAs), graphical processing units (GPUs), logic circuits, and any other circuit or processor capable of executing the various operations and functions described herein. The above examples are examples only, and are thus not intended to limit in any way the definition or meaning of the term “unit.”

In some embodiments, the various units described herein may be included in or otherwise implemented by processing circuitry such as a microprocessor, microcontroller, or the like.

The objects and effects of the present disclosure, and technical constitutions for accomplishing these will become obvious with reference to exemplary embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention or a usual practice of a user or an operator.

However, the present disclosure is not limited to exemplary embodiments disclosed below but may be implemented in various different forms. However, the exemplary embodiments are provided to make the present disclosure be complete and completely announce the scope of the present disclosure to those skilled in the art to which the present disclosure belongs. Accordingly, the terms need to be defined based on contents throughout this specification.

It is to be understood that the accompanying drawings are just used for easily understanding the exemplary embodiments disclosed in this specification and a technical spirit disclosed in this specification is not limited by the accompanying drawings and all changes, equivalents, or substitutes included in the spirit and the technical scope of the present disclosure are included.

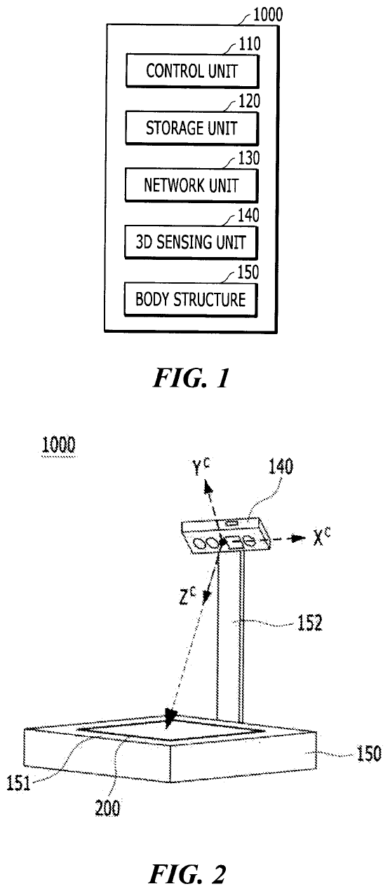

FIG. 1 is a block diagram of a volume measurement apparatus 100 according to some exemplary embodiments of the present disclosure.

A configuration of the volume measurement apparatus 100 illustrated in FIG. 1 is only an example illustrated through simplification. In some exemplary embodiments of the present disclosure, the volume measurement apparatus 100 may include other components for performing a volume measurement function and other functions and only some of the disclosed components may constitute the volume measurement apparatus 100.

In some examples, the volume measurement apparatus 100 may be an apparatus for a volume management system (VMS). For example, the volume measurement apparatus 100 may measure a volume of an object by using depth information for the object. In some examples, the volume measurement apparatus 100 may be an unmanned parcel receiving machine. For example, the volume measurement apparatus 100 recognizes objects having various sizes through a 3D sensing circuit 140 (also referred to as “a 3D sensing unit 140”) to measure a width, a length, and a height of the object in real time in order to increase logistics loading and transportation efficiency. However, the present disclosure is not limited thereto and the volume measurement apparatus 100 may include various devices.

Referring to FIG. 1, the volume measurement apparatus 100 may include a control circuit 110 (also referred to as “a control unit 110”), a storage unit 120, a network unit 130, a 3D sensing unit 140, and a body structure 150. However, the present disclosure is not limited thereto, and the volume measurement apparatus 100 may include other components according to a usage thereof, and only some of the disclosed components may constitute the volume measurement apparatus 100. For example, when the volume measurement apparatus 100 is an unmanned parcel receiving machine, the volume measurement apparatus 100 may further include at least one of a weight measurement unit, a camera unit, a user input unit, a display unit, and a sound output unit. However, the present disclosure is not limited thereto and the volume measurement apparatus 100 may include various components.

The control unit 110 may generally process an overall operation of the volume measurement apparatus 100. The control unit 110 processes a signal, data, information, and the like input or output through the components included in volume measurement apparatus 100 or drives an application program stored in the storage unit 120 to provide or process information or a function appropriate for a user. In some examples, when the volume measurement apparatus 100 is the unmanned parcel receiving machine, the control unit 110 may process various operations for providing a parcel delivery service jointly with a volume measurement function.

In some exemplary embodiments of the present disclosure, the control unit 110 may perform a volume measurement method according to the present disclosure. The volume measurement method will be described in detail with reference to FIGS. 2 to 9.

The storage unit 120 may include a memory and/or a persistent storage. The memory may include at least one type storage of a flash memory type storage, a hard disk type storage, a multimedia card micro type storage, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 120 may generally store various information used in a process of processing the overall operation of the volume measurement apparatus 100. According to some exemplary embodiments of the present disclosure, the storage unit 120 may store various data in a process of performing the volume measurement method. For example, the storage unit 120 may store a target depth image or a calibration depth mage generated through the 3D sensing unit 140. As another example, the storage unit 120 may store various information received from the outside. The data stored in the storage unit 120 may be displayed to a display unit (not illustrated) or transmitted to another device.

The network unit 130 may be configured regardless of communication modes such as wired and wireless modes and constituted by various communication networks including a local area network (LAN), a wide area network (WAN), and the like. The network unit 130 may transmit/receive various data in the process of performing the volume measurement method according to the present disclosure. The data received through the network unit 130 may be displayed to the display unit (not illustrated) or transmitted to another device.

The 3D sensing unit 140 may acquire depth information. In some examples, the 3D sensing unit 140 may be based on various technologies such as a laser displacement sensor (profiler), a stereo camera, a laser or LIDAR distance measurement camera, a TOF camera/sensor, an RGB-D camera, a structured light camera, and various other manual or active distance sensing technologies. In some examples, the 3D sensing unit 140 may generate a depth image such as the target depth image or the calibration depth mage. In this case, the 3D sensing unit 140 may generate point cloud data of an imaged object. The point cloud data may include a set of 3D points in a space in which each point i may be expressed as (Xi, Yi, Zi). The point cloud data may express a 3D object including a rear surface and a side surface, a top surface, and a bottom surface of the object. The 3D points Xi, Yi, and Zi may indicate a location in a space in which the object is visible in the camera. However, the present disclosure is not limited thereto, and the 3D sensing unit 140 may acquire the depth information by various schemes.

The body structure 150 may form an exterior of the volume measurement apparatus 100. The exterior of the volume measurement apparatus 100 may be formed variously according to a usage thereof. In addition, the body structure 300 may include the control unit 110, the storage unit 120, the network unit 130, the 3D sensing unit 140, and other components. However, the present disclosure is not limited thereto and the volume measurement apparatus 100 may include various components according to the usage thereof.

According to some exemplary embodiments of the present disclosure, the volume measurement apparatus 100 may measure the volume of the object placed on the reference surface by using the depth information (point cloud data) acquired by the 3D sensing unit 140 installed in the sensing direction which is the acute angle with respect to the reference surface. When the depth information is acquired in a sensing direction vertical to the object, the depth information acquired in the vertical sensing direction indicates a height of the object immediately so as to easily determine the volume of the object.

However, in order to position a 3D sensing device in a vertical direction to the object, the volume measurement apparatus should have a large volume to install the 3D sensing device at an upper portion of the object or include an element such as a mount arm which is projected long forward and causes user's inconvenience. In particular, the 3D sensing device needs to have a minimum spacing distance for measurement. Therefore, when a height of the object to be measured is increased, a sensing location of the 3D sensing device should also be increased. In this case, the volume measurement apparatus has disadvantages in that the exterior may become larger, the volume measurement apparatus may be installed only in a limited place, and manufacturing and installation cost is increased.

According to some exemplary embodiments of the present disclosure, the volume measurement apparatus 100 may acquire the point cloud data for the reference surface coordinate system from the target depth image by using transformation relationship information between the sensing coordinate system and the reference surface coordinate system. The point cloud data for the reference surface coordinate system may be expressed in the form of a bird-eye view image which is the vertical direction to the object. Therefore, the volume measurement apparatus 100 according to the present disclosure may provide the same effect as acquiring the depth information in the sensing direction which is vertical to the object.

In the volume measurement apparatus 100 according to the present disclosure, since the 3D sensing unit 140 has the sensing direction which is the acute angle to the reference surface, an installation location of the 3D sensing unit 140 for securing the minimum spacing distance for measurement may be lower than the installation location when the 3D sensing unit 140 is installed in the vertical sensing direction. In this case, the volume measurement apparatus 100 may have an advantage in that the volume measurement apparatus 100 may be manufactured in a small size in which manufacturing cost is low and installation is easy. Further, the 3D sensing unit 140 installed to have the sensing direction which is the acute angle may provide an effect of being capable of detecting an object having a larger volume at the same viewing angle as compared with the vertical sensing direction. Consequently, the present disclosure may provide the volume measurement apparatus 100 that provides an improved effect for a VMS solution.

Hereinafter, an example of performing the volume measurement method by the volume measurement apparatus 100 according to the present disclosure will be described with reference to FIGS. 2 to 9.

Referring to FIG. 2, the exemplary volume measurement apparatus 100 may be the unmanned parcel receiving machine. As illustrated in FIG. 2, the volume measurement apparatus 100 may include a body structure 150 forming an exterior of the unmanned parcel receiving machine. In some examples, the volume measurement apparatus 100 may measure the volume of the target object positioned on the reference surface. The reference surface may mean a plane which becomes a reference for measuring the volume of the object by the volume measurement apparatus 100. In other words, the reference surface may mean a plane having a height of 0 with respect to the object. Referring to FIG. 2, the body structure 150 may include a stand 151 for stably installing the volume measurement apparatus 100 on the bottom. The stand 151 may have an upper plane on which a target object for which volume is to be measured may be placed. In this case, the body structure 150 may arrange the 3D sensing unit 140 to face the upper plane. In this case, the volume measurement apparatus 100 may set an area included in the upper plane of the stand 151 as the reference surface for measuring the volume of the object.

The 3D sensing unit 140 may have the sensing direction which is the acute angle with respect to the reference surface. As described above, when the 3D sensing unit 140 has the sensing direction which is the acute angle with respect to the reference surface, the installation location of the 3D sensing unit 140 which may secure the minimum spacing distance may be lowered. Further, the 3D sensing unit 140 may detect an object having a larger volume at the same viewing angle.

In some examples, as illustrated in FIG. 2, the 3D sensing unit 140 may be installed on an upper end of a support 152 extended upward from one surface of the stand 151. In addition, the 3D sensing unit 140 may be disposed to face the upper plane of the stand 151 included in the reference surface. In this case, the 3D sensing unit 140 may have the sensing direction which is the acute angle with respect to the reference surface. Referring to FIG. 2, the 3D sensing unit 140 having the sensing direction which is the acute angle with respect to the reference surface may acquire a depth image expressed as a sensing coordinate system having a Z axis as the sensing direction. In other words, the control unit 110 may acquire the depth image expressed as the sensing coordinate system by the 3D sensing unit 140. Since the sensing direction is not vertical with respect to the reference surface, the height of the object positioned on the reference surface may not be immediately calculated by using the depth image for the sensing coordinate system. Therefore, the volume measurement apparatus 100 may use the transformation relationship information between the sensing coordinate system and the reference surface coordinate system for volume measurement.

According to some exemplary embodiments of the present disclosure, the control unit 110 may determine the transformation relationship information between the sensing coordinate system and the reference surface coordinate system for the sensing direction.

In order to transform the sensing coordinate system into the reference surface coordinate system, the control unit 110 may determine the transformation relationship information between the sensing coordinate system and the reference surface coordinate system for a current sensing direction. A process of determining the transformation relationship information between the sensing coordinate system and the reference surface coordinate system for the current sensing direction may be referred to as a calibration for the reference surface. The calibration for the reference surface may be performed when the volume measurement apparatus 100 is installed or when the location of the 3D sensing unit 140 is adjusted. The calibration for the exemplary reference surface may be performed as the following process.

According to some exemplary embodiments of the present disclosure, the control unit 110 may acquire a calibration depth image for the reference surface based on the sensing direction by the 3D sensing unit 140. For example, in a state in which any object is not placed on the reference surface, the 3D sensing unit 140 may acquire the calibration depth image including a depth value for a pixel of an area which enters the viewing angle. In this case, the calibration depth image may be acquired by imaging a value (depth value) of the z on an xy plane according to the sensing coordinate system.

According to some exemplary embodiments of the present disclosure, the control unit 110 may acquire point cloud data 210 corresponding to the reference surface based on the calibration depth image.

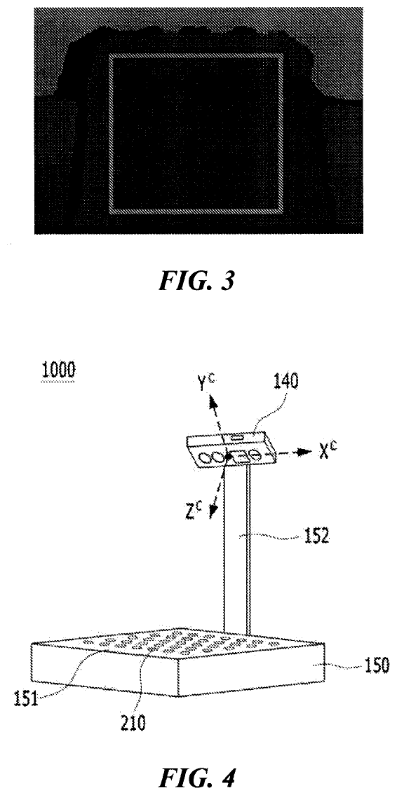

After acquiring the calibration depth image, the control unit 110 may designate an area corresponding to the reference surface on calibration depth image as a region of interest 200. Referring to FIG. 3, a calibration depth image is illustrated in which a partial area on the upper plane of the stand 151 is designated as the region of interest 200 corresponding to the reference surface. In some examples, in order to designate the reference surface which is the region of interest 200 on the calibration depth image, the control unit 110 may use a segmentation technique. For example, when the segmentation technique is used, the control unit 110 may acquire point cloud data for all pixels on the calibration depth image. The control unit 110 may determine a point cloud area approximated to the plane by using a RANdom SAmple consensus (RANSAC) technique from the point cloud data acquired from the calibration depth image. In this case, the control unit 110 may determine the point cloud area approximated to the plane as the region of interest 200. In addition, the control unit 110 may acquire the point cloud area approximated to the plane as the point cloud data 210 corresponding to the reference surface. In some examples, multiple planes may also be detected according to the installation location of the volume measurement apparatus 100. In this case, the control unit 110 may determine a plane closest to the 3D sensing unit 140 as the reference surface. Referring to FIG. 4, the point cloud data 210 corresponding to the exemplary reference surface is displayed, which is acquired from the calibration depth image.

According to some exemplary embodiments of the present disclosure, the control unit 110 may determine an equation of the plane for the reference surface based on the point cloud data 210 corresponding to the reference surface.

According to some exemplary embodiments of the present disclosure, in order to determine the transformation relationship information, the control unit 110 may determine an equation of the plane for defining the reference surface by using the point cloud data 210 corresponding to the reference surface. The control unit 110 may use various algorithms approximating the plane by using the 3D points. For example, the control unit 110 may determine the equation of the plane for the reference surface by applying a singular value decomposition (SVD) to the point cloud data 210 corresponding to the reference surface. An exemplary SVD process is as follows.

One point ‘p’ expressed in the sensing coordinate system may be expressed as the following vector.

$$p = [ \begin{matrix}x \\ y \\ z\end{matrix} ] \qquad Equation 1$$

When N points on the reference surface which is the region of interest are p₁, p₂, . . . , P_{N}, a centroid matrix p̅ of the points may be defined as follows.

$$\overline{p} = [ \begin{matrix}x \\ y \\ z\end{matrix} ] , \qquad Equation 2$$

$$\overline{x} = \frac{{x}_{1} + {x}_{2} + … + {x}_{N}}{N}$$

$$\overline{y} = \frac{{y}_{1} + {y}_{2} + … + {y}_{N}}{N}$$

$$\overline{z} = \frac{z {y}_{1} + {z}_{2} + … + {z}_{N}}{N}$$

Meanwhile, a point cloud matrix constituted by N points may be defined as follows.

$$P = [ {p}_{1} {p}_{2} … {p}_{N} ] \qquad Equation 3$$

Here, the following \tilde{P} matrix constituted by differences of respective points from the centroid may be obtained.

$$\tilde{P} = P - \overline{P} , \qquad Equation 4$$

$$P = [ \overline{{p}_{1}} \overline{{p}_{2}} … \overline{{p}_{N}} ]$$

A result of performing the SVD for the \tilde{P} matrix is as follows.

$$\tilde{P} = U Σ {V}^{T} \qquad Equation 5$$

Since a vector p is a 3D vector, a rank of \tilde{P} is 3. As a result, a unit vector matrix U of the reference surface may be expressed as three left singular vectors as follows.

$$U = [ {u}_{1} {u}_{2} {u}_{3} ] \qquad Equation 6$$

By an SVD property, u₁, u₂, and u₃ may be orthonormal vectors which are orthogonal to each other and have a size of 1.

Further, u₁, u₂, and u₃ represent in which directions respective points are distributed based on the centroid, and may face a direction having a larger distribution in order. That is, u₁ and u₂ as vectors placed on a plane to be approximated may face two axes where the points are most widely distributed, respectively. In addition, since u₃ faces a direction where the distributions of the points are the smallest, u₃ may become a normal vector of the plane to be approximated. Therefore, A, B, C corresponding to the normal vector in the equation of the plane may be obtained as follows.

$$[ \begin{matrix}A \\ B \\ c\end{matrix} ] = {u}_{3} \qquad Equation 7$$

Further, D may be calculated as follows according to a property of the equation of the plane.

$$D = - {\overline{p}}^{T} {u}_{3} \qquad Equation 8$$

Therefore, the equation of the plane approximated to the points in the reference surface as follows may be obtained as follows.

$$Ax + By + Cz + D = 0 \qquad Equation 9$$

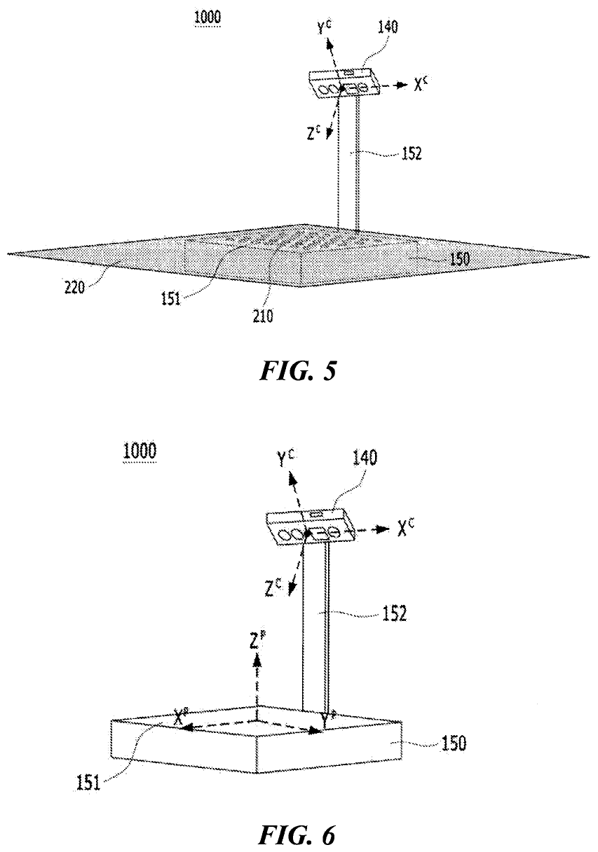

Through the SVD process, the control unit 110 may determine Ax+By+Cz+D=0 which is the equation of the plane for the reference surface. Referring to FIG. 5, a plane 220 is illustrated, which is defined by the equation of the plane for the reference surface. As described below, the point cloud data (or bird-eye view image) for the reference surface coordinate system transformed through the transformation relationship information may represent the height based on the plane 220 defined by the equation of the plane for the reference surface. In other words, the plane 220 defined by the equation of the plane for the reference surface may represent a location where the height is 0.

According to some exemplary embodiments of the present disclosure, the control unit 110 may determine the transformation relationship information between the sensing coordinate system and the reference surface coordinate system based on the equation of the plane for the reference surface. Here, the transformation relationship information between the sensing coordinate system and the reference surface coordinate system for the sensing direction may include a translation transformation matrix and a rotation transformation matrix.

Specifically, a coordinate transformation of the sensing coordinate system and the reference surface coordinate system may be achieved by translation and rotation. The rotation transformation matrix which defines the rotation transformation may be determined according to in which direction x-axis and y-axis directions of the reference surface coordinate system are determined. In some examples, referring to FIG. 6, when distribution directions of the points constituting the point cloud data for the reference surface are used as they are, the unit vector matrix U of the reference surface calculated in the process of performing the SVD may be used as the rotation transformation matrix and the centroid matrix p may be used as the translation transformation matrix. In other words, the rotation transformation matrix R may be the unit vector matrix U of the reference surface according to the sensing coordinate system, and the rotation transformation matrix t may be the centroid matrix \tilde{p} of the point cloud data 210 corresponding to the reference surface according to the sensing coordinate system.

$$R = U \qquad Equation 10$$

$$t = {\overline{p}}^{c}$$

The transformation relationship information between the sensing coordinate system and the reference surface coordinate system including the translation transformation matrix and the rotation transformation matrix is as follows.

$${p}^{c} = {Rp}^{p} + \text{} t ( transformation from the reference surface coordinate system to the sensing coordinate system ) \qquad Equation 11$$

$${p}^{p} = {R}^{T} {p}^{c} - {R}^{T} t ( transformation from the sensing coordinate system to the reference surface coordinate system )$$

Here, p^{c} may represent the sensing coordinate system, p^{p} may represent the reference surface coordinate system, R^{T} may represent a transposed matrix of the rotation transformation matrix, and t may represent the translation transformation matrix.

When the transformation relationship information between the sensing coordinate system and the reference surface coordinate system is determined according to the process, the control unit 110 may measure the volume for the target object by using the transformation relationship information between the sensing coordinate system and the reference surface coordinate system.

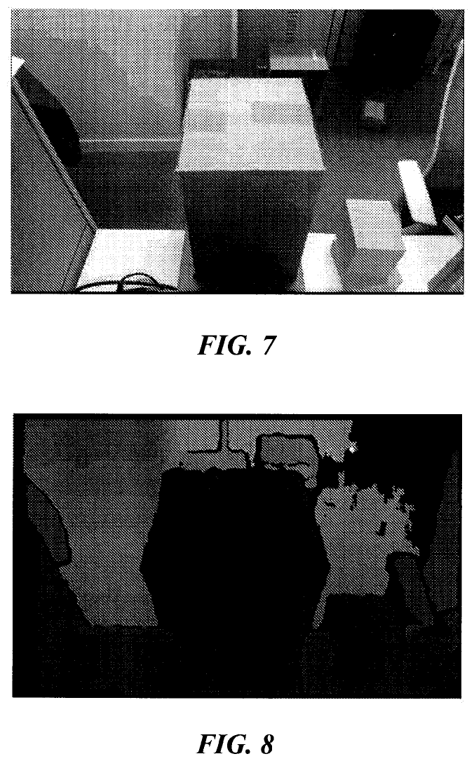

Hereinafter, an example of measuring the volume for the target object by the volume measurement apparatus 100 which is the unmanned parcel receiving machine will be described with reference to FIGS. 7 to 9. For easy description, according to the example, it is assumed that the control unit 110 sets the area included in the upper plane of the stand 151 of the volume measurement apparatus 100 which is the unmanned parcel receiving machine to the reference surface for measuring the volume of the object, and then determines the transformation relationship information between the sensing coordinate system and the reference surface coordinate system for the sensing direction.

According to some exemplary embodiments of the present disclosure, the control unit 110 may acquire the target depth image for the target object positioned on the reference surface by the 3D sensing unit 140. Here, the 3D sensing unit 140 may have the sensing direction which is the acute angle with respect to the reference surface.

Referring to FIG. 7, a state is illustrated in which the target object is placed on the stand 151 of the volume measurement apparatus 100 which is the unmanned parcel receiving machine. In this case, the control unit 110 may acquire the target depth image through the 3D sensing unit 140 having the sensing direction which is the acute angle with respect to the area included in the upper plane of the stand 151 of the volume measurement apparatus 100 set as the reference surface.

According to some exemplary embodiments of the present disclosure, the control unit 110 may acquire the point cloud data for the sensing coordinate system based on the target depth image.

FIG. 8 illustrates an exemplary target depth image acquired by a 3D sensing unit 140 having a sensing direction which is an acute angle for the reference surface. As illustrated in FIG. 8, the target depth image may be acquired by imaging the value of the z axis on the xy plane in the sensing coordinate system. The control unit 110 may acquire the point cloud data for the sensing coordinate system with respect to all pixels of the target depth image. Since the sensing direction is not vertical with respect to the reference surface, the height of the object positioned on the reference surface may not be immediately calculated by using the point cloud data for the sensing coordinate system. Therefore, the control unit 110 may use the transformation relationship information between the sensing coordinate system and the reference surface coordinate system determined according to the sensing direction in order to measure the volume of the target object.

According to some exemplary embodiments of the present disclosure, the control unit 110 may acquire the point cloud data for the reference surface coordinate system by using the transformation relationship information between the sensing coordinate system and the reference surface coordinate system for the sensing direction.

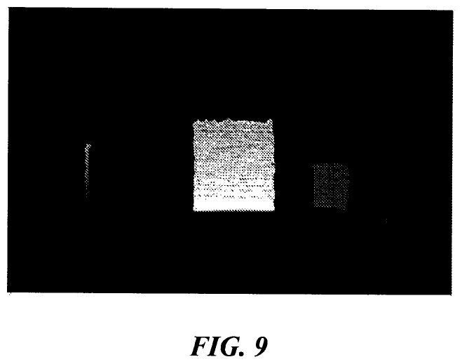

Specifically, the control unit 110 may transform the point cloud data for the sensing coordinate system to a state to calculate the height of the object positioned on the reference surface by using the transformation relationship information between the sensing coordinate system and the reference surface coordinate system. FIG. 9 illustrates the point cloud data for the reference surface coordinate system acquired by using the transformation relationship information between the sensing coordinate system and the reference surface coordinate system. As illustrated in FIG. 9, the point cloud data for the reference surface coordinate system may include a bird-eye view image corresponding to the target depth image. In other words, the point cloud data for the reference surface coordinate system may include an image acquired by transforming the target depth image in a direction vertical to the reference surface. Therefore, the control unit 110 may easily determine the height of the target object by using the point cloud data for the reference surface coordinate system.

According to some exemplary embodiments of the present disclosure, the control unit 110 may determine the volume of the target object based on the point cloud data for the reference surface coordinate system.

As described above, since the point cloud data for the reference surface coordinate system may include the bird-eye view image corresponding to the target depth image, the control unit 110 may determine the height of the target object by using the z-axis value of the point cloud data for the reference surface coordinate system. Further, the control unit 110 may determine a horizontal/vertical length of the target object by using an x-axis value and a y-axis value of the point cloud data for the reference surface coordinate system. In this case, the control unit 110 may determine the volume of the target object by using the height, and the horizontal/vertical length of the target object.

In some examples, when the volume measurement apparatus 100 is the unmanned parcel machine, the target object may have a rectangular parallelepiped shape which a parcel item generally has. When the target object has the rectangular parallelepiped shape, the control unit 110 may identify a top surface of the target object in order to determine the height of the target object. The control unit 110 may determine an area of the target object by using an x-axis value and a y-axis value of the identified top surface. In addition, the control unit 110 may determine the height of the target object by using a z-axis value of the identified top surface. In this case, the control unit 110 may measure the volume of the target object by using the area and the height of the target object having the rectangular parallelepiped shape.

As another example, the target object may have an atypical shape. In this case, the control unit 110 may measure an approximate value for the volume of the target object by using a cube type bounding box. Specifically, the control unit 110 may determine the cube type bounding box of the target object based on the point cloud data for the reference surface coordinate system. The control unit 110 may determine a horizontal/vertical length of the cube type bounding box of the target object through a rectangular bounding area of the target object identified through the bird-eye view image. In addition, the control unit 110 may determine a height of the cube type bounding box by using some among z-axis values (height values) of the rectangular bounding area. For example, the control unit 110 may determine the height of the cube type bounding box by using a maximum value of the z-axis value of the rectangular bounding area. As another example, so as not to use an outlier value, the control unit 110 may determine the height of the cube type bounding box by using a representative value (e.g., a mean value, a median value, etc.) of the z-axis value of the rectangular bounding area. In this case, the control unit 110 may approximate and determine the volume of the target object having the atypical shape by using the height, and the horizontal/vertical length of the cube type bounding box having the rectangular parallelepiped shape.

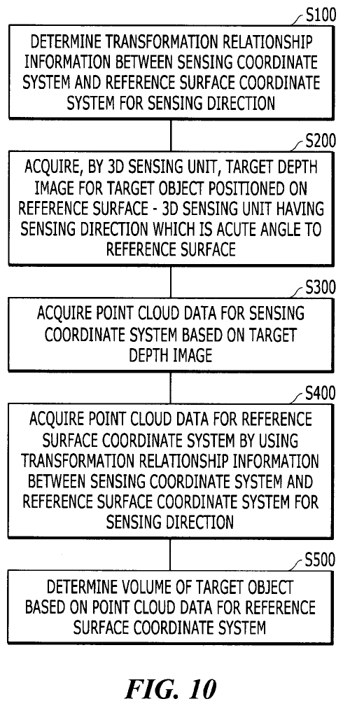

FIG. 10 is a flowchart of a volume measurement method according to some exemplary embodiments of the present disclosure.

According to some exemplary embodiments of the present disclosure, the volume measurement method may include determining transformation relationship information between a sensing coordinate system and a reference surface coordinate system for a sensing direction (s100).

Alternatively, the determining of the transformation relationship information between the sensing coordinate system and the reference surface coordinate system for the sensing direction (s100) may include: acquiring, by a 3D sensing unit, a calibration depth image for a reference surface based on the sensing direction; acquiring point cloud data corresponding to the reference surface based on the calibration depth image; determining an equation of a plane for the reference surface based on the point cloud data corresponding to the reference surface; and determining the transformation relationship information between the sensing coordinate system and the reference surface coordinate system for the sensing direction based on the equation of the plane for the reference surface.

Alternatively, the determining of the equation of the plane for the reference surface based on the point cloud data corresponding to the reference surface may include determining the equation of the plane by applying a singular value decomposition to the point cloud data corresponding to the reference surface.

According to some exemplary embodiments of the present disclosure, the volume measurement method may include acquiring, by the 3D sensing unit, a target depth image for a target object positioned on the reference surface (s200). Here, the 3D sensing unit may have the sensing direction which is an acute angle with respect to the reference surface.

According to some exemplary embodiments of the present disclosure, the volume measurement method may include acquiring point cloud data for the sensing coordinate system based on the target depth image (s300).

According to some exemplary embodiments of the present disclosure, the volume measurement method may include acquiring point cloud data for the reference surface coordinate system by using the transformation relationship information between the sensing coordinate system and the reference surface coordinate system for the sensing direction (s400).

According to some exemplary embodiments of the present disclosure, the volume measurement method may include determining the volume of the target object based on the point cloud data for the reference surface coordinate system (s500).

Alternatively, the determining of the volume of the target object based on the point cloud data for the reference surface coordinate system (s500) may include identifying a top surface of the target object in order to determine a height of the target object when the target object has a rectangular parallelepiped shape.

Alternatively, the determining of the volume of the target object based on the point cloud data for the reference surface coordinate system (s500) may include determining a cube type bounding box of the target object based on the point cloud data for the reference surface coordinate system when the target object has an atypical shape; and determining approximate values of a width, a length, and a height of the target object by using the cube type bounding box of the target object.

The steps according to some exemplary embodiments of the present disclosure described above are presented just for description, and some steps may be omitted or separate steps may be added. Further, the steps may be performed according to an arbitrary order.

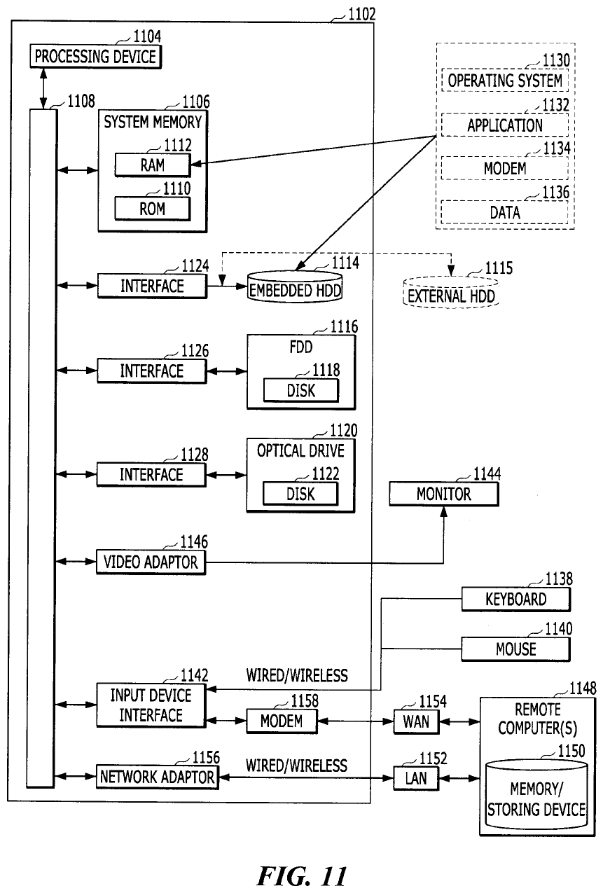

FIG. 11 is a simple and normal schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable instruction and/other program modules which may be executed on one or more computers and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which selected (or predetermined) tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a selected (or predetermined) processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as the Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be analyzed within the widest range which is coherent with the principles and new features presented herein.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method performed by a computing device, the method comprising:
acquiring, by a 3D sensing unit, a target depth image for a target object positioned on a reference surface, wherein the 3D sensing unit has a sensing direction which is an acute angle with respect to the reference surface;
acquiring point cloud data for a sensing coordinate system based on the target depth image; and
acquiring point cloud data for a reference surface coordinate system by using transformation relationship information between the sensing coordinate system and the reference surface coordinate system for the sensing direction.

2. The method of claim 1, wherein the transformation relationship information between the sensing coordinate system and the reference surface coordinate system includes a rotation transformation matrix and a translation transformation matrix.

3. The method of claim 2, wherein the rotation transformation matrix is a unit vector matrix of the reference surface according to the sensing coordinate system, and the rotation transformation matrix is a centroid matrix of the point cloud data corresponding to the reference surface according to the sensing coordinate system.

4. The method of claim 3, wherein the transformation relationship information between the sensing coordinate system and the reference surface coordinate system is based on
$${p}^{p} = {R}^{T} {p}^{c} - {R}^{T} t$$
where, p^{c} represents the sensing coordinate system, p^{p} represents the reference surface coordinate system, R^{T} represents a transposed matrix of the rotation transformation matrix, and t represents the translation transformation matrix.

5. The method of claim 1, further comprising:
determining the transformation relationship information between the sensing coordinate system and the reference surface coordinate system for the sensing direction.

6. The method of claim 5, wherein the determining of the transformation relationship information between the sensing coordinate system and the reference surface coordinate system for the sensing direction includes:
acquiring, by the 3D sensing unit, a calibration depth image for the reference surface based on the sensing direction,
acquiring point cloud data corresponding to the reference surface based on the calibration depth image,
determining an equation of a plane for the reference surface based on the point cloud data corresponding to the reference surface, and determining the transformation relationship information between the sensing coordinate system and the reference surface coordinate system for the sensing direction based on the equation of the plane for the reference surface.

7. The method of claim 6, wherein the determining of the equation of the plane for the reference surface based on the point cloud data corresponding to the reference surface includes:
determining the equation of the plane by applying a singular value decomposition to the point cloud data corresponding to the reference surface.

8. The method of claim 1, wherein the point cloud data for the reference surface coordinate system includes a bird-eye view image corresponding to the target depth image.

9. The method of claim 1, further comprising:
determining a volume of the target object based on the point cloud data for the reference surface coordinate system.

10. The method of claim 9, wherein the determining of the volume of the target object based on the point cloud data for the reference surface coordinate system includes:
identifying a top surface of the target object in order to determine a height of the target object when the target object has a rectangular parallelepiped shape.

11. The method of claim 9, wherein the determining of the volume of the target object based on the point cloud data for the reference surface coordinate system includes:
determining a cube type bounding box of the target object based on the point cloud data for the reference surface coordinate system when the target object has an atypical shape, and
determining approximate values of a width, a length, and a height of the target object buy using the cube type bounding box of the target object.

12. A non-transitory computer readable storage storing a computer program, wherein the computer program includes instructions for causing one or more processors to perform a method, the method comprising:
acquiring, by a 3D sensing unit, a target depth image for a target object positioned on a reference surface, wherein the 3D sensing unit has a sensing direction which is an acute angle with respect to the reference surface;
acquiring point cloud data for a sensing coordinate system based on the target depth image; and
acquiring point cloud data for a reference surface coordinate system by using transformation relationship information between the sensing coordinate system and the reference surface coordinate system for the sensing direction.

13. A volume measurement apparatus, comprising:
a 3D sensing unit having a sensing direction which is an acute angle with respect to a reference surface;
a body structure forming an exterior of the volume measurement apparatus, and arranging a stand having an upper plane on which a target object may be placed and the 3D sensing unit to face the upper plane; and
a control unit,
wherein the control unit
acquires a target depth image for the target object positioned on a reference surface by the 3D sensing unit,
acquires point cloud data for a sensing coordinate system based on the target depth image,
acquires point cloud data for a reference surface coordinate system by using transformation relationship information between the sensing coordinate system and the reference surface coordinate system for the sensing direction, and
determines a volume of the target object based on the point cloud data for the reference surface coordinate system.
